(19) United States
(12) Patent Application Publication
(10) Pub. No.: US 2003/0186654 A1
(43) Pub. Date: Oct. 2, 2003

(54) Incoming call radio distributing apparatus, mobile call center system and operator radio station

(76) Inventors: Isao Shigemura, Fukuoka (JP); Tsutomu Sumita, Fukuoka (JP); Kazuya Nisimura, Fukuoka (JP); Yasushi Yano, Fukuoka (JP)

Correspondence Address: KATTEN MUCHIN ZAVIS ROSENMAN, 575 MADISON AVENUE, NEW YORK, NY, 10022-2585, US

(21) Appl. No.: 10/280,681

(22) Filed: Oct. 25, 2002

(30) Foreign Application Priority Data
Mar. 29, 2002 (JP) 2002-095438

(51) Int. Cl. H04M 1/00

(52) U.S. Cl. 455/67.13; 455/560

(57) ABSTRACT

An incoming call radio distributing apparatus provided in a communication system to distribute incoming calls to radio stations, which has a receiving station selecting unit selecting an available operator radio station for an incoming call among a plurality of operator radio stations for responding to incoming calls on the basis of states of communication of the plural operator radio stations, and an incoming call distributing unit preferentially connecting the incoming call to an operator radio station selected by the selecting unit. It is thereby possible to configure a mobile call center employing a mobile station as an operator station, provide station communications where calls are difficult to be disconnected, and high communication quality, a wide transmission band are available, and realize operator work not bound to a specific place.

### BACKGROUND OF THE INVENTION

(1) Field of the Invention

The present invention relates to an incoming call radio distributing apparatus, a mobile call center system and an operator radio station suitable for use of incoming call distribution of group incoming calls in a mobile communication system employing a radio link, for example.

(2) Description of Related Art

An increasing number of enterprises install a switching center configuring a communication network, where a switching center or an information apparatus such as a computer or the like is disposed in the public network and a private network. The call center is an installation for supporting customers or handling claims from the customers. A market using the call center keeps spreading year after year. As examples of services to be handled by the call center, well known are giving advice to consumers, accepting reservations, handling claims, providing information on products and services, receiving orders, giving technical supports, etc. An enterprise operating a call center provides a number of receivers in the call center, and an operator is stationed at each of the receivers. The call center system has a function generally called ACD (Automatic Call Distribution) to uniformly distribute calls (incoming calls) which are coming in to the plural receivers.

A personal computer is disposed at the receiver, and information on the customer is displayed thereon to improve the services. Namely, the operator specifies a customer who is making a telephone call on the basis of a telephone number of the incoming call, obtains individual information or the like on the customer from a database, and deals with the customer while looking the information on the customer.

Making customers wait when all the receivers are busy (hereinafter referred as congestion) leads to degradation of the services. Degradation of the services may cause loss of a customer and opportunity of a large transaction. For this, each enterprise has to have a number of operators in a call center beforehand prepared to provide the services.

Enterprises are demanded by customers to extend a time period during which the operators deal with the customers, in recent years. On the other hand, it becomes difficult for the enterprises to secure labor, thus the enterprises pay attention not to bind the operators in a specific place. In order to secure labor of the operators to be increased and powerful labor of housewives or the like who have work experiences, at-home work of the operators attracts attention. If possible, the enterprise enables the operators to do the operator work at home or outside, while housewives can have opportunities to work. Accordingly, the corporation can gather personnel as operators relatively easily, and provide higher-quality services to the customers.

A technique enabling operators to do operator work at home is disclosed in Japanese Patent Laid-Open Publication No. 2001-086244 (hereinafter referred as a known publication). The known publication discloses a system and a method of realizing a homeagent-client function for a call center system. In concrete, the technique realizes the homeagent-client function for a call center system by handling simultaneous communication of voice and/or data (hereinafter referred as voice/data) in association with an agent-client in a call center over an analog subscriber line or ISDN (Integrated Services Digital Network) line.

The above idea of working at home is promoted in recent years, so that a mobile call center, in which a portable telephone or a PHS (Personal Handy Phone System), or a mobile station such as a dual mode station which can use both a portable telephone and a PHS is applied as an operator station of the computer, is rapidly popularized as a new form of work. A call center having this mobile station has an advantage that the operator is not bound to a place, thus the operator can work even in a place far away from the call center.

Another advantage of using a portable device is that almost the portable devices have a high-level communication function for both voice and data. Use of a portable device is considered to be the optimum communication infrastructure (hereinafter referred as infrastructure) from a viewpoint that the operator can do his/her operation work for a call center at home.

A carrier of a mobile communication network provides various services such as communication of only voice, communication of only data, etc. to mobile stations. For this, an enterprise operating a call center is required to provide a simultaneous communication service of voice/data coping with the both functions of the portable device.

However, the current mobile communication network services such as PDC (Personal Digital Cellular) , cdmaOne (registered trademark of Nihon Ido Tsushin Kabushiki Kaisha), PHS, etc. cannot provide simultaneous communication of voice/data with a portable device. Since the simultaneous communication of speech (voice)/data is indispensable for the operator work in a call center, realization of a mobile call center is almost impossible in systems of the present carriers.

On the other hand, IMT-2000 (International Mobile Telecommunications-2000), which is a standard of the next generation radio communication, has already started commercial services. The services based on IMT-2000 meet elements such as simultaneous communication of voice/data, high-bit-rate data communication and high secrecy considered to be essential when a computer is applied as an operator station.

As this, it can be said that infrastructure for enabling the operator work even in a remote place in radio is getting ready, by applying a portable device as an operator station of a call center.

By applying a portable device as an operator station of a call center as above, it becomes possible to configure a call center where the operators have a higher degree of freedom with respect to a place and working time to do the operator work as compared with conventional call centers.

When a portable device is applied as an operator station of a call center, there is a possibility that the voice/data line in service is disconnected due to degradation of the radio quality, drain of the radio resource, etc., and the communication is disconnected during conversation with a customer. That conversation with a customer is disconnected while the operator is communicating with the customer using a portable device is fatal in the call center operation. Accordingly, realization of a mobile call center is impossible unless this problem is solved. In order to realize a mobile call center, to overcome items (1-1) to (1-3) described below is essential.

(1-1) a method of determining an operator having a high speech quality (securing a high-quality speech with a customer).

(1-2) a method of determining an operator who can secure a sufficient transmission band (securing a throughput at the time of transfer of customer data).

(1-3) a method of determining an operator who is difficult to be disconnected (avoiding loss of an opportunity of business talk with a customer).

In order to accomplish (1-3), a method of determining an operator having a low frequency of movement (frequency representing how many times the operator moves within a predetermined time of period) (avoiding possibility of disconnect due to hand-over), and a method of determining an operator having low possibility of congestion of adjacent cells (avoiding disconnect due to drain of the resource of a cell to which the operator moves) are essential.

### SUMMARY OF THE INVENTION

In the light of the above problems, an object of the present invention is to provide an incoming call radio distributing apparatus, a mobile call center system and an operator radio station in a mobile call center where a mobile station is applied as the operator station, thereby to realize a high communication quality, a wide transmission band, stable communication during which the call is not disconnected, and the operator work that can be done in any place.

The present invention therefore provides an incoming call radio distributing apparatus distributing incoming calls to radio stations comprising a selecting unit for selecting an available operator radio station for an incoming call among a plurality of operator radio stations for responding to incoming calls on the basis of states of communication of the plural operator radio stations, and an incoming call distributing unit for preferentially connecting the incoming call to the available operator radio station selected by the selecting unit.

Accordingly, it is possible to select a subscriber having a good communication state for a receiving call, and apply a mobile station to which the call can be preferentially connected as the operator station. In concrete, elements such as selection of a radio quality state of the mobile station, selection of a radio resource state in a cell to which the mobile station is handed over, securement of a radio resource in a cell to which the mobile station is handed over, etc. that the network can actively influence among elements causing disconnection of the communication when a call is coming in to a mobile station that is an operator station are eliminated as much as possible, whereby probability of disconnection of the communication with a selected mobile station is largely decreased as compared with a case where this invention is not applied.

The present invention further provides an incoming call radio distributing apparatus distributing incoming calls to radio stations comprising a communication quality estimating unit for estimating information on communication qualities of a plurality of operator radio stations for responding to incoming calls, an information managing unit for managing operator radio station information on available operator radio stations for an incoming call among the plural operator radio stations on the basis of information on communication qualities of the communication quality estimating unit, and a receiving station determining unit for determining operator radio stations for the incoming call on the basis of operator radio terminal information managed by the information managing unit.

Accordingly, it is possible to determine not less than one operator as the receiving station or the receiving candidate station in the registration table, and connect an incoming call to a subscriber having a good communication state. This can diminish probability of disconnection of the communication, enable a real mobile call center system to be configured. As a secondary effect, the operator can do his/her call center work in a free time convenient to him/her since the operator station is a radio station, thus limitations of requirements for the operator work are largely moderated.

The communication quality estimating unit may comprise a radio quality measuring unit for measuring radio qualities of the plural operator radio stations, and a resource managing unit for managing a state of resource relating to a communication band of each cell with respect to each of the plural operator radio stations. In such case, it is possible to connect an incoming call to a subscriber having a better radio quality state. Further, a radio resource necessary to obtain a desired communication quality is secured, thus an incoming call is connected to a subscriber having a high communication quality.

The communication quality estimating unit may estimate information on a communication quality by managing states of communication of adjacent cells to a cell to which each operator radio station belongs. In which case, it is possible to connect an incoming call to a subscriber who can keep an ample communication quality even after the operator moves to an adjacent cell during the communication.

The communication quality estimating unit may estimate information on a communication quality by managing a frequency of movement of each operator radio station. In which case, an incoming call can be connected to a subscriber having a low frequency of movement.

The communication quality estimating unit may estimate information on a communication quality on the basis of a noise level around each operator radio station. In which case, it is possible to connect an incoming call to a subscriber having less ambient noise.

The incoming call radio distributing apparatus may further comprise a throughput measuring unit for transferring predetermined data to each of operator radio stations for the incoming call determined by the receiving radio station determining unit, and measuring a receiving state of sent-back data therefrom, and a responding terminal determining unit for determining an operator radio station for the incoming call among a plurality of available operator radio stations for the incoming call grouped by the information managing unit or the receiving station determining unit on the basis of measurement by the throughput measuring unit. In which case, it is possible to connect an incoming call to a sole subscriber having a high speech quality.

The information managing unit has a table holding at least not less than one kind of information on radio qualities, states of resource, states of adjacent cells, frequencies of movement, noise levels or throughputs of the plural operator radio stations. In which case, an enterprise providing the call center can readily obtain labor of operators.

The present invention still further provides a mobile call center system in which a plurality of operators receive a plurality of incoming calls comprising a plurality of operator radio stations for responding to incoming calls, a selecting unit for selecting an available operator radio station for an incoming call among the plural operator radio stations on the basis of states of communication of the plural operator radio stations, and an incoming call distributing unit for preferentially connecting the incoming call to an operator radio station selected by the selecting unit.

Accordingly, operators in sufficient number to cope with accesses from customers at any time can be secured, the connectivity is improved to allow attendance on customers all the time, and high services can be realized.

The present invention still further provides a mobile call center system in which a plurality of operators receive a plurality of incoming calls comprising a plurality of operator radio stations for responding to incoming calls, a communication quality estimating unit for estimating information on communication qualities of the plural operator radio stations, an information managing unit for managing operator radio station information on available operator radio stations for an incoming call among the plural operator radio stations on the basis of information on communication qualities of the communication quality estimating unit, and a receiving station determining unit for determining an operator radio station for the incoming call on the basis of operator radio station information managed by the information managing unit.

Accordingly, it is possible to determine an operator having a high communication quality, and secure a high-quality conversation with a customer. Further, it is possible to determine an operator who can secure an ample transmission band, and secure a throughput at the time of transfer of customer data. Still further, it is possible to determine an operator who is difficult to be disconnected, and avoid loss of business talk with a client. For example, an operator who has a low frequency of movement is determined, thus disconnection due to hand-over is avoided. An operator who has low possibility of congestion of the adjacent cells is determined, thus disconnection due to drain of the resource in a cell to which the operator moved is avoided.

The present invention still further provides an operator radio station responding to an incoming call coming in to an incoming call radio distributing apparatus distributing incoming calls to radio terminals comprising a radio transmitting-receiving unit for transmitting and receiving radio signals including sent-back data, and a noise level detecting unit for detecting a noise level therearound, and inputting data relating to the noise level to the radio transmitting-receiving unit. Accordingly, a result of detection by the noise level detecting unit is judged by the noise level judging unit, thus an incoming call can be connected to a mobile station having less ambient noise.

### BRIEF DESCRIPTION OF THE DRAWINGS

FIG. 1 is a diagram for illustrating a mobile call center system according to an embodiment of this invention;

FIG. 2 is a diagram showing an example of the structure of a communication network according to the embodiment of this invention;

FIG. 3 is a diagram showing an example of the structure of a mobile call center system according to the embodiment of this invention;

FIG. 4 is a diagram showing a modified example of the mobile call center system according to the embodiment of this invention;

FIG. 5 is a diagram showing an example of a group registration table according to the embodiment of this invention;

FIG. 6 is a diagram showing an example of cell arrangement according to the embodiment of this invention;

FIG. 7 is a diagram showing an example of an adjacent cell information management table according to the embodiment of this invention;

FIG. 8 is a diagram showing an example of a resource management table according to the embodiment of this invention;

FIG. 9 is a diagram showing an example of a cell congestion state management table according to the embodiment of this invention;

FIG. 10 is a diagram showing an example of a movement frequency management table according to the embodiment of this invention;

FIG. 11 is a diagram showing an example of a noise level management table according to the embodiment of this invention;

FIG. 12 is a diagram showing an example of a radio quality management table according to the embodiment of this invention;

FIG. 13 is a flowchart for illustrating a radio quality measuring method according to the embodiment of this invention;

FIG. 14 is a flowchart for illustrating a resource state measuring method according to the embodiment of this invention;

FIG. 15 is a flowchart for illustrating a movement frequency measuring method according to the embodiment of this invention;

FIG. 16 is a flowchart for illustrating a noise level measuring method according to the embodiment of this invention;

FIG. 17 is a flowchart for illustrating an incoming candidate operator determining method according to the embodiment of this invention;

FIG. 18 is a flowchart for illustrating a responding operator determining method according to the embodiment of this invention; and

FIG. 19 is a diagram showing an example of a known technique.

### DESCRIPTION OF THE PREFERRED EMBODIMENTS

Hereinafter, description will be made of embodiments of this invention with reference to the drawings.

(A) Description of an Embodiment of the Invention

A call center to which this invention is applied is used to support customers, handle claims from the customers, give advice to the customers, accept reservations, provide information about products and services, receive business orders, give technical supports, etc., as well.

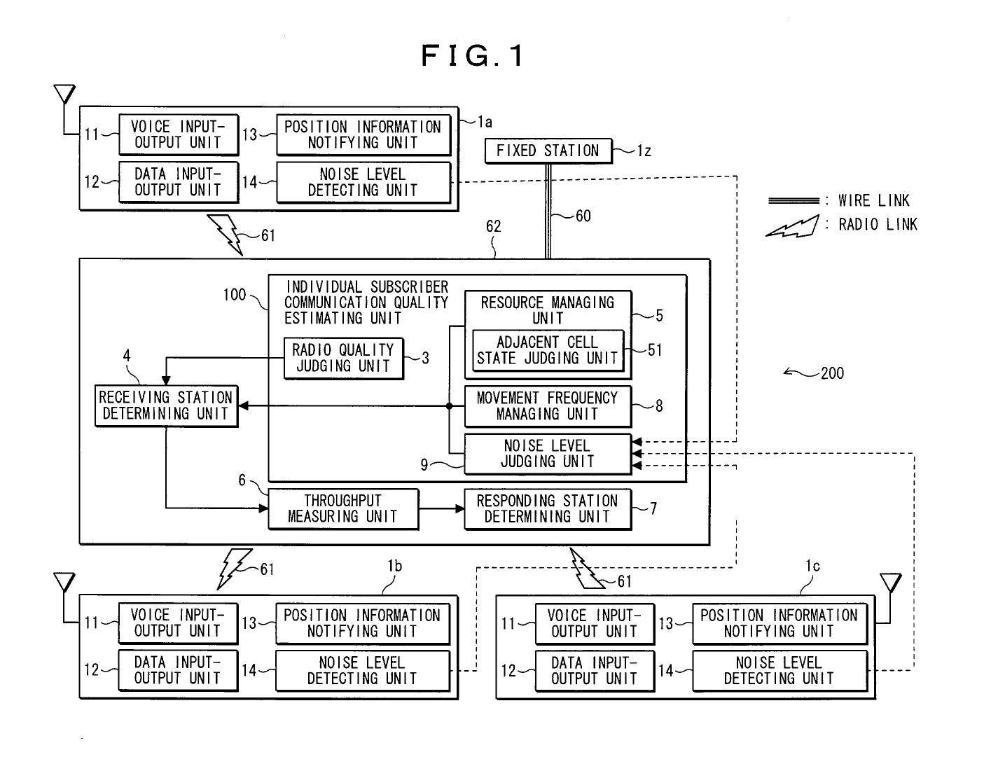

FIG. 1 is a diagram for illustrating a mobile call center system according to the embodiment of this invention. The mobile call center system 200 shown in FIG. 1 is a call center system in which a plurality of operators accept a plurality of incoming calls. An operator accepts inquiries, or orders of products or the like from customers on the telephone. The mobile call center 200 is configured with, for example, mobile stations 1a, 1b and 1c, a fixed station 1z, and a communication network 62 including an individual subscriber communication quality estimating unit (a communication quality estimating unit) 100, an receiving station determining unit 4 for determining a receiving station, etc.

In the following descriptions, the mobile stations 1a through 1c signify subscriber stations of a portable type, and the fixed station 1z signifies a subscriber station of a fixed type. The receiving station signifies a mobile station (a receiving mobile station) used by an operator to respond to an incoming call. As the mobile station, a PHS terminal, a dual mode station of portable telephone and PHS, or the like may be used. Incidentally, a responding station signifies a radio station or a fixed station responding to an incoming call, being used as a radio station used mainly by an operator if not specifically mentioned.

Here, the operator is a subscriber (a receiving subscriber) of the mobile communication system, signifying a person who operates a receiving candidate station or a receiving station other than the fixed station. Further, the operator radio station includes, for example, a personal computer or an information device having a radio function, other than that of a mobile type, along with the receiving station.

In the mobile call center system 200 (and 200a and 200b to be described later) of this invention, the call center 20 also provides information to the customers, but description of which will be omitted unless specifically mentioned.

The individual subscriber communication quality estimating unit 100 provided in the communication network 62 estimates information (communication quality information) on the communication quality of each of the plural mobile stations (operator radio stations) 1a through 1c responding to incoming calls. The communication quality information is information representing communication environments, which are elements for determining receiving candidate stations. The communication quality information is information about, for example, radio quality, speech quality, state of resource, state of adjacent cells, frequency of movement, noise level, throughput, etc. The individual subscriber communication quality estimating unit 100 manages the communication quality of an operator radio station used by a subscriber as an operator, and selects a suitable operator radio station.

Here, the radio quality is a physical quality such as signal to interference ratio (SIR: Signal to Interference Ratio), BER (Bit Error Rate) or FER (Frame Error Rate). The speech quality is articulation of speech or text data. The state of resource means a band of a radio channel which can be secured between the mobile station 1a, 1b or 1c and the base station. The state of adjacent cells represent a state of congestion in respect to a cell on the basis of a state of the resource and a threshold value beforehand prepared. The frequency of movement represents how many times the mobile station 1a, 1b or 1c is handed over within a predetermined period of time. The noise level is a level computed on the basis of a sound pressure level in a band differing from the voice band. The throughput is a result of measurement of the throughput of a desired operator station.

The receiving terminal determining unit 4 determines an operator radio station for an incoming call among the mobile stations 1a through 1c on the basis of the communication quality information of the individual subscriber communication quality estimating unit 100. The mobile call center system 200 can select a mobile station 1a, 1b or 1c having a good communication quality for an incoming call to be received (hereinafer referred as a receiving call), and preferentially connects the call from a customer to it, so that the mobile station 1a, 1b or 1c can be applied as an operator station.

Hereinafter, the above units will be described.

(1) Mobile Stations 1a Through 1c and Fixed Station 1z

Each of the mobile stations 1a through 1c is a subscriber station such as a portable telephone or the like responding to an incoming call, which functions as the operator radio station of an operator. Each of the mobile stations 1a through 1c comprises a voice input-output unit 11, a data input-output unit 12, a position information notifying unit 13 and a noise level detecting unit 14, along with a radio transmitting-receiving unit for transmitting and receiving radio signals (including sent-back data to be described later), and a radio antenna although not shown.

The voice input-output unit 11 is for conversation between a customer and an operator. The data input-output unit 12 transmits/receives data to/from the call center 20. The position information notifying unit 13 notifies of position information on the mobile station 1a, 1b or 1c in order that the mobile station 1a, 1b or 1c registers its position to the communication network 62.

The noise level detecting unit 14 detects noise or a noise level around its own mobile station 1a, 1b or 1c, and inputs data representing the noise level to the radio transmitting-receiving unit. For example, the noise level detecting unit 14 obtains a sound pressure level in a band (a band higher than the voice band or a band lower than the same) differing from the voice band as the noise level, detects the noise level on the basis of a ratio of the magnitude, and notifies of the noise level. Incidentally, various methods are employable as a method of selecting a band for obtaining the sound pressure level, a method of weighting the sound pressure level so selected and obtained, a method of computing the weighted data, etc.

Each of the mobile stations 1a through 1c is connected to the individual subscriber communication quality estimating unit 100 over a radio link 61 of a radio transmission path. The individual subscriber communication quality estimating unit 100 estimates the communication quality on the basis of the noise level around the operator radio terminal. The noise level detected by the noise level detecting unit 14 is notified to the individual subscriber communication quality estimating unit 100 (refer to dotted lines in FIG. 1). Accordingly, results of detection by the noise level detecting units 14 are judged by the noise level judging unit 9, so that a mobile station 1a, 1b or 1c having less ambient noise can receive an incoming call.

The fixed station 1z is a subscriber station such as a fixed telephone set or the like disposed at home, or in a business office or the like, which is connected to the individual subscriber communication quality estimating unit 100 over a wire link 60 of a wire transmission path.

(2) Communication Network 62

(2-1) Individual Subscriber Communication Quality Estimating Unit 100

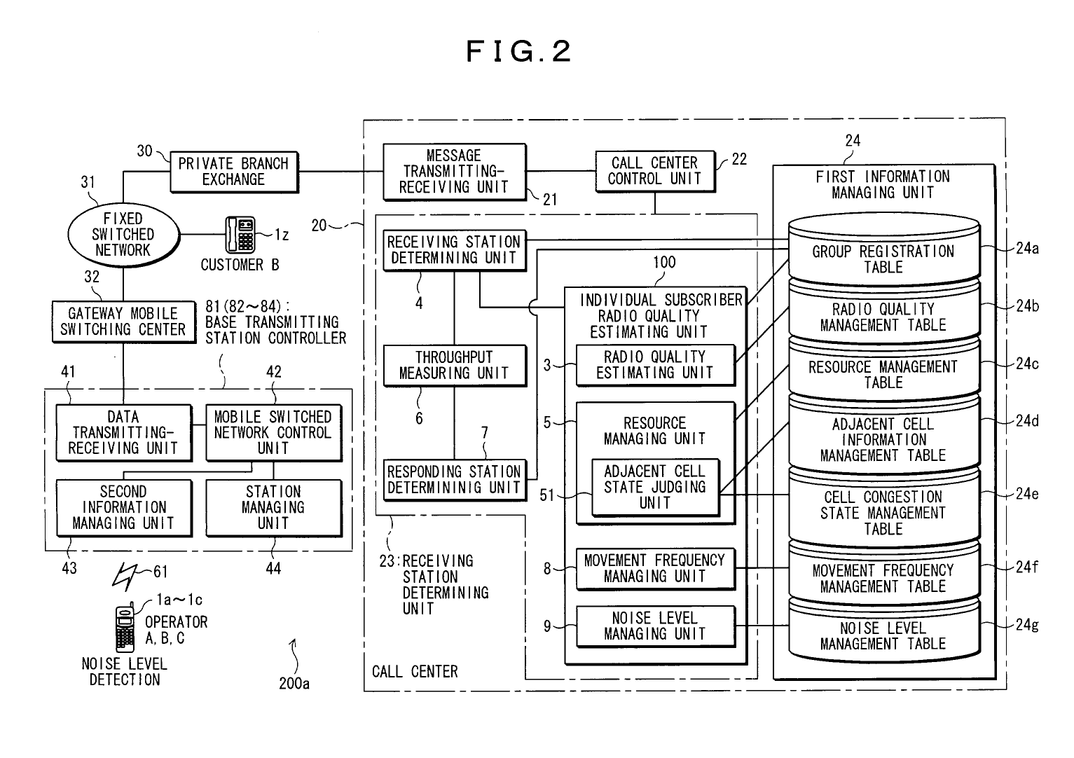

The individual subscriber communication quality estimating unit 100 can accumulate data transmitted from each of the mobile stations 1a through 1c and the fixed station 1z. According to this embodiment, the individual subscriber communication quality estimating unit 100 is provided in, for example, a call center 20 shown in FIG. 2. Incidentally, the individual subscriber communication quality estimating unit 100 may be provided in any one of various apparatus and networks connected to the communication network 62, not limited to the call center 20.

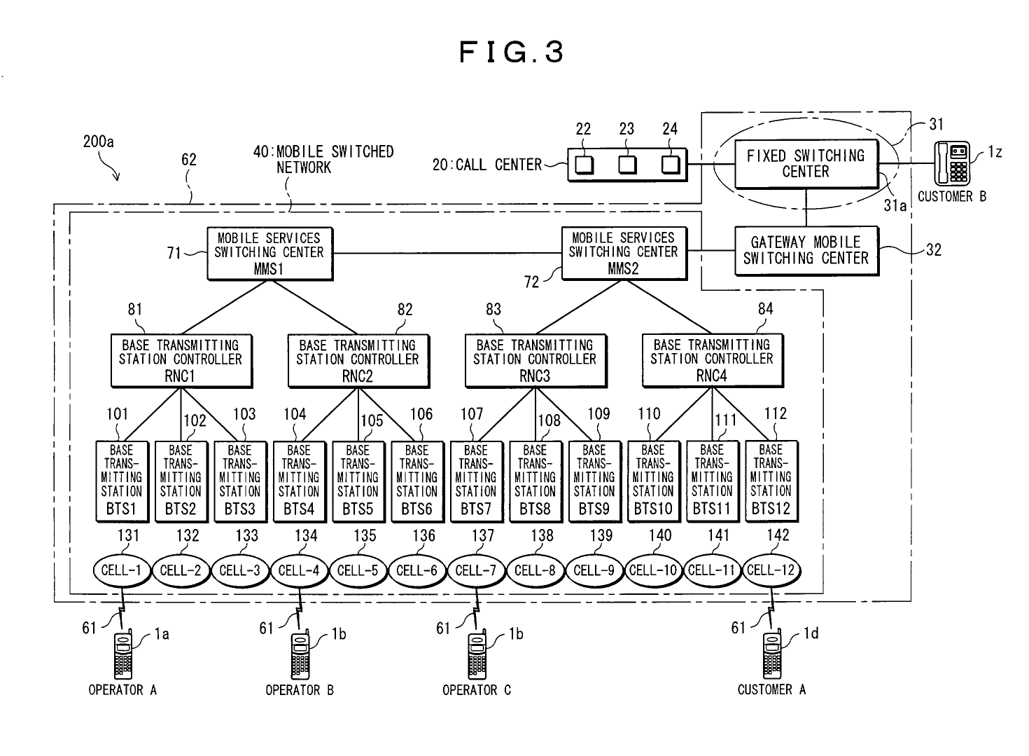

FIG. 3 is a diagram showing an example of the structure of the communication network 62 according to the embodiment of this invention. The communication network 62 shown in FIG. 3 is a network for wire communications and radio communications, which comprises a mobile switched network 40, a gateway mobile switching center (GMSC: Gateway Mobile Switching Center) 32 and a fixed switched network 31. Units or parts designated by the same reference characters in FIG. 3 have the same or similar functions described above, further descriptions of which are thus omitted.

(2-2) Mobile switched network 40

The mobile switched network 40 has mobile services switching centers (MMS: Mobile Services Switching center, hereinafter referred as a mobile switching center) 71 and 72, radio network controllers (RNC: Radio Network Controller, hereinafter referred as a base transmitting station controller) 81 through 84, and base transmitting stations 101 through 112. The mobile switched network 40 can be connected to not only mobile stations (MS: Mobile Station) 1a through 1c but also a mobile station 1d having the similar function to those of the mobile stations 1a through 1c. The mobile stations 1a through 1c are used by operators. The mobile station 1d is used by, for example, a customer A.

(2-2-1) Base Transmitting Stations 101-112

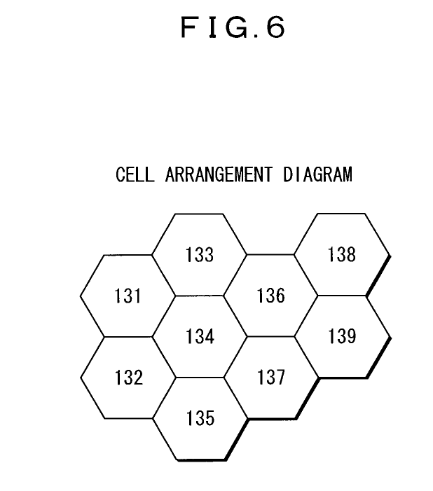

The base transmitting stations 101 through 112 are apparatus communicating with mobile stations 1a through 1d over the radio links 61, each of which is mainly configured with an RF (Radio Frequency) circuit (not shown) having a radio signal transmitting-receiving function. Cells 131 through 142 (CELL-1 through CELL-12) correspond to the base transmitting stations 101 through 112, respectively. As shown in FIG. 6, for example, each of the base transmitting stations 101 through 112 corresponds to a region schematically shown, to which a transmitted radio wave can reach. The mobile stations 1a through 1c belong to the cells 131, 134 and 137, and connected in radio to the base transmitting stations 101, 104 and 107, respectively. Namely, the base transmitting stations 101 through 112 manage the mobile stations la through 1c in units of cell.

(2-2-2) Base Transmission Station Controllers 81 Through 84

Each of the base transmitting station controllers 81 through 84 controls a plurality of the base transmitting stations 101 through 112, and repeats signals between another switched network and the mobile stations 1a, 1b or 1d. The base transmitting station controller 81 among them comprises, as shown in FIG. 2, a data transmitting-receiving unit 41, a mobile switched network control unit 42, a second information managing unit 43 and a station managing unit 44. The data transmitting-receiving unit 41 transmits/receives data to/from the call center 20, and the fixed station 1z or the like belonging to a fixed switched network 31.

The mobile switched network control unit 42 is connected to the data transmitting-receiving unit 41 to control execution of a request for a pseudo test included in data transmitted from the call center 20, and transmits a result of the pseudo test to the call center 20 via the data transmitting-receiving unit 41. In concrete, the mobile switched network control unit 42 requests the station managing unit 44 to execute the pseudo test on, for example, the mobile station la designated by the call center 20, and transmits a result of the pseudo test from the station managing unit 44.

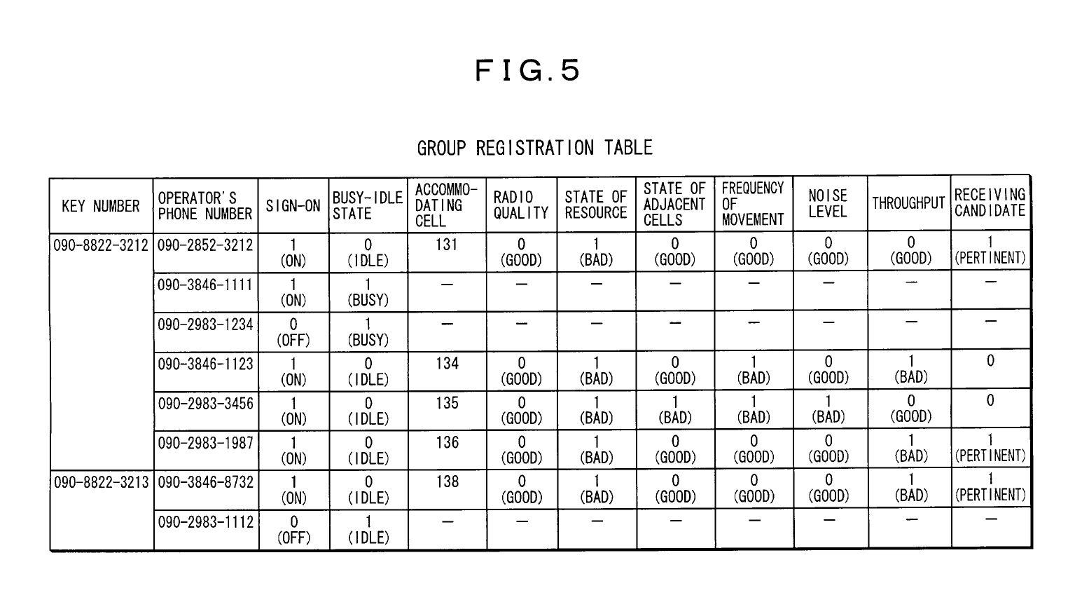

The station managing unit 44 transmits data of a unit quality as the pseudo test to, for example, the mobile station 1a, and receives sent-back data of the data of the unit quality from the mobile station 1a, thereby measuring the throughput of the mobile station 1a. The station managing unit 44 notifies the mobile switched network control unit 42 of a result of the throughput measurement as a result of the test. Incidentally, an example of the throughput measurement will be described later with reference to FIG. 5.

The second information managing unit 43 holds the obtained result of the throughput measurement, information on a measured noise level, etc. The second information managing unit 43 relates each of the mobile stations 1a through 1c with its history of hand-over, and holds it, which functions as an information managing unit. This function is accomplished by, for example, a RAM (Random Access Memory), a hard disk, or a writable record medium other than these. The base transmitting station controllers 82 through 84 have the identical structure to the base transmitting station 81, duplicated description of which is thus omitted.

When the call center 20 transmits the same data to each of the mobile stations 1a through 1c, predetermined data is sent back between the base transmitting station controller 81 (or the base transmitting station controller 82, 83 or 84) and the mobile station 1a (1b or 1c), and a time period required to send back the data and a data quantity of the sent-back data are held in the second information managing unit 43. The held data is read by the mobile switched network control unit 42, and transmitted to the call center 20.

When the call center 20 requests, for example, the mobile station 1a to detect the noise level, the noise level is detected between the base transmitting station controller 81 and the mobile station 1a, 1b or 1c, and an obtained result of the noise level measurement is held in the second information managing unit 43.

(2-2-3) Mobile Switching Centers 71 and 72

The mobile switching centers 71 and 72 shown in FIG. 3 control the base transmitting station controllers 81 through 84, the base transmitting stations 101 through 112 and the mobile stations 1a through 1d to control switching of the mobile communications.

When a customer A belonging to the cell 142 calls the call center 20 using the mobile station 1d, the signals are repeated to the mobile switching center 72 via the base transmitting station 112 and the base transmitting station controller 84. The signals are repeated to any one of the mobile stations 1a through 1c by the call center 20. Namely, signals are transmitted and received between the mobile station 1d and the mobile station 1c via the base transmitting station controller 83 and the base transmitting station 107, whereas signals are transmitted and received between the mobile station 1d and each of the mobile station 1a and the mobile station 1b via the mobile switching station 71, the base transmitting station controllers 81 and 82, and the base transmitting stations 101 and 102.

When a customer B accesses to each of the mobile stations 1a through 1c using the fixed station 1z, signals are transmitted via the gateway mobile switching center 32, etc.

(2-3) Fixed Switched Network 31 and Gateway Mobile Switching Center 32

The fixed switching network 31 is a network in which a plurality of fixed switching centers 31a are mutually connected. The fixed switching center 31a is a switching center switching the fixed station 1z and the like. The gateway mobile switching center 32 is provided at a position where the two different kinds of networks, that is, the mobile switched network 40 and the fixed switched network 31, are connected, having a function of allowing a call having a telephone number determined beforehand in the contract to pass therethrough.

The mobile station 1z is connected to the mobile switched network 40 via the fixed switching center 31a and the gateway mobile switching center 32.

(3) Call Center 20

FIG. 2 is a diagram showing an example of the structure of a mobile call center system according to the embodiment of this invention. The mobile call center system 200a shown in FIG. 2 has a function almost identical to that of the mobile call center system 200, comprising a base transmitting station controller 81, a gateway mobile switching center 32, a fixed switched network 31, a private branch exchange 30 and a call center 20. The private branch exchange 30 is a PBX (Private Branch Exchange) disposed in a building.

The call center 20 is an installation for accepting an inquiry from a customer B on the telephone, an order for a product, etc. by a number of operators. The call center 20 is operated by an enterprise, which uses and manages a number of mobile stations 1a through 1c as an attendant board in order to respond to a number of incoming calls.

Meanwhile, units and parts designated by the same reference characters in FIG. 2 have the same or similar functions to those described above. Hereinafter, description will be made by way of example where the individual subscriber communication quality estimating unit 100, etc. are intensively disposed in the call center 20, but these may be dispersed in the communication network 62 (refer to FIG. 1) to configure the call center system 200.

The call center 20 shown in FIG. 2 functions as an incoming call radio distributing apparatus for distributing incoming calls to radio stations, which comprises a message transmitting-receiving unit 21, a call center control unit 22, a receiving station selecting unit 23 having the above individual subscriber communication quality estimating unit 100, and a first information managing unit 24.

The message transmitting-receiving unit 21 is connected to the private branch exchange 30 on the side of the fixed switched network 31 to transmit/receive message data to/from the mobile communication network. The call center control unit 22 has a function of controlling transmission and reception of the message data, and a function of selecting a receiving station for responding to an incoming call from a customer.

(3-1) Receiving Station Selecting Unit 23, First Information Managing Unit 24, and Incoming Call Distributing Unit (22, 23 and 24)

The receiving station selecting unit 23 selects an available operator radio station for an incoming call among a plurality of operator radio stations on the basis of states of communication of the plural operator stations for responding to incoming calls, functioning as a selecting unit. In concrete, the receiving station selecting unit 23 selects a mobile station 1a, 1b or 1c for an incoming call, so that the radio link 61 is not disconnected while the customer calls.

The first information managing unit 24 mainly holds information for selecting one of the mobile stations 1a through 1c in the receiving station selecting unit 23. The first information managing unit 24 and the receiving station selecting unit 23 determine in cooperation a suitable receiving station.

The receiving station selecting unit 23, the first information managing unit 24 and the above call center control unit 22 function in cooperation as an incoming call distributing unit (22, 23 and 24). The incoming call distributing unit (22, 23 and 24) connects an incoming call preferentially to the available operator radio station selected by the receiving station selecting unit 23.

When the customer B calls the call center 20 using the fixed station 1z, the call is transmitted over the fixed switched network 31, and received by the call center (an incoming call radio distributing apparatus) 20. This incoming call is responded by a mobile station (an operator radio station) 1a, 1b or 1c beforehand selected by the receiving station selecting unit 23.

The mobile station 1a (1b or 1c) can respond to the customer B in radio communication with the base transmitting station controller 81 (82, 83 or 84). The enterprise operating the call center 20 can thereby support the customer or handle a claim from the customer.

The receiving station selecting unit 23 comprises a receiving station determining unit 4, a throughput measuring unit 6 and a responding station determining unit 7 along with an individual subscriber communication quality estimating unit 100. The receiving station determining unit 4 determines an operator radio station for an incoming call on the basis of operator radio station information managed by the first information managing unit 24. The receiving station determining unit 4 determines receiving candidate stations (receiving candidate subscriber stations) on the basis of information measured by the individual subscriber communication quality estimating unit 100. The receiving station determining unit 4 is connected to a group registration table 24a, determines not less than one operator as a receiving station or a receiving candidate station in the group registration table 24a, and connects an incoming call preferentially to a mobile station 1a, 1b or 1c having a good state of the communication quality.

The group registration table 24a is a table holding information about radio quality, state of resource, state of adjacent cells, frequency of movement, noise level, throughput, etc. of each of the mobile stations 1a through 1c. The group registration table 24a is updated by the individual subscriber communication quality estimating unit 100, and referred by the receiving station determining unit 4 and the responding station determining unit 7.

Meanwhile, a function of each of the individual subscriber communication estimating unit 100 and the receiving station determining unit 4, and the throughput measuring unit 6 and the responding station determining unit 7 both to be described later, is accomplished by a work station, a personal computer or the like.

The throughput measuring unit 6 transfers predetermined data to an operator radio station determined by the receiving radio station determining unit 4 or each of plural available mobile stations 1a through 1c for an incoming call, and measures a receiving state of sent-back data. Whereby, it is measured whether an operator to receive an incoming call can secure a sufficient communication quality when responding to the incoming call.

The responding station determining unit 7 determines an operator radio station for an incoming call among a plurality of available operator radio stations for an incoming call grouped by the first information managing unit 24 on the basis of measurement by the throughput measuring unit 6. The responding station determining unit 7 refers to each of receiving candidate determining elements (for example, radio quality, state of resource, state of adjacent cells, frequency of movement, noise level and throughput) in the group registration table 24a, determines the most suitable receiving station on the basis of the priority of each of the elements, the number of times of past incoming calls, etc. The responding station determining unit 7 can also notify the call center control unit 22 of it in order that the responding station and the customer get into a talkable state.

As above, a receiving station for response is determined on the basis of results obtained by the receiving station determining unit 4 and the throughput measuring unit 6, whereby a call from the customer is connected to a sole mobile station 1a, 1b or 1c having a high speech quality.

(3-2) Individual Subscriber Communication Quality Estimating Unit 100 and First Information Managing Unit 24

The individual subscriber communication quality estimating unit 100 comprises a radio quality measuring unit 3, a resource managing unit 5, a movement frequency managing unit 8 and a noise level judging unit 9. The first information managing unit 24 manages operator radio station information about available operator radio stations for an incoming call among a plurality of operator radio stations on the basis of communication quality information of the individual subscriber communication quality estimating unit 100. The first information managing unit 24 comprises a group registration table 24a, a radio quality management table 24b, a resource management table 24c, an adjacent cell information management table 24d, a cell congestion state management table 24e, a movement frequency management table 24f and a noise level management table 24g.

(3-2-1) Radio Quality Measuring Unit 3 and Radio Quality Management Table 24b

The radio quality measuring unit 3 measures the radio quality of each of a plurality of operator radio stations. The radio quality is used to represent a distance between each of the base transmitting stations 101 through 112 (refer to FIG. 3) and a corresponding mobile station 1a, 1b or 1c. Namely, the radio quality measuring unit 3 writes “0 (good)” representing that the radio quality is good when the distance is short in a column of “radio quality” shown in FIG. 5, for example, while writing a special flag representing that the radio quality degrades when the distance is long in the same, thereby representing it.

As the radio quality, used is data relating to a transmitting power control between each of the mobile stations 1a through 1c and a corresponding base transmitting station 101, 102, . . . or 112 to which the mobile station 1a, 1b or 1c belongs. Namely, each of the base transmitting stations 101 through 112 shown in FIG. 3 holds data relating to the transmitting power control, and is requested by the call center 20 to transmit the data to the call center 20. Each of the base transmitting stations 101 through 112 transmits the data to the call center 20 in response to the request. When receiving the data, the radio quality measuring unit 3 (refer to FIG. 2) writes the data in the radio quality management table 24b.

The radio quality measuring unit 3 can use, as the radio quality, quality such as articulation of speech or text data, along with physical quality such as signal to interference ratio, BER or the like. The radio quality management table 24b holds radio quality data obtained by the radio quality measuring unit 3.

The radio quality measuring unit 3 writes results of the radio quality measurement in the radio quality management table 24b, ranks the receiving mobile stations 1a through 1c in the order an incoming call should be connected on the basis of the results of the radio quality measurement, then makes results of the ranking be reflected in the column of “radio quality” of the group registration table 24a.

FIG. 5 is a diagram showing an example of the group registration table according to the embodiment of this invention. A key number (for example, 090-8822-****) shown in FIG. 5 is a telephone number of the call center 20. When a customer dials this number, the call is connected to any one of mobile stations of six operators (operators 1 through 6 [an operator's phone stands for a telephone number of an operator]). Here, “sign-on” (sign-on state) is data showing the intention of an operator that the operator can receive an incoming call. Namely, five operators excepting the third operator displaying “sign-off” can receive an incoming call. “Busy-idle state” is data showing “busy” or “idle” at present. “Operator's phone” signifies a telephone number of each operator, which is common in FIGS. 11 through 17.

Other data will be further described in detail. “Accommodating cell” represents which cell 131, 132, . . . , or 139 (refer to FIG. 6) the operator belongs to. “Radio quality” is data obtained on the basis of a distance between the mobile station 1a, 1b or 1c and a corresponding base transmitting station 101, 102, . . . , or 112. “State of resource” signifies a band of a radio channel that can be secured between the mobile station 1a, 1b or 1c and a corresponding base transmitting station 101, 102, . . . , or 112, for example, where “1” represents that the band is extremely small. “State of adjacent cells” represents a state of congestion of cells on the basis of a state of resource and a threshold value beforehand prepared. When there is no congestion, the state of adjacent cells is “0 (good)”. When there is congestion, the state of adjacent cells is “1 (bad)”.

“Frequency of movement” (Movement frequency) shows how many times the mobile station 1a, 1b or 1c is handed-over within a predetermined time period. When the execution history of hand-over is large/small, it is represented by “1 (bad)/0 (good)”.

“Noise level” is represented by “1 (bad)/0 (good)” on the basis of a sound pressure level in a band differing from the voice band. For example, a level of a band higher than the voice band or band lower than the same is obtained, and a value obtained by weighting and operating it is used. “Throughput” is a result of throughput measurement of a desired operator station, represented by “1 (bad)/0 (good)”. Data of a unit quality is transmitted as the pseudo test from a base transmitting station 101, 102, . . . , or 112, then a corresponding mobile station 1a, 1b or 1c sends back the data to the base transmitting station 101, 102, . . . , or 112. A result of measurement obtained on the basis of a time period required for the sending-back or the sent-back data within a predetermined time period is used as “throughput”. For example, each of sending-back time periods of the operator stations is measured, and one responding within predetermined milliseconds is judged to be “0 (good)”. Reason of this is that a bit error occurs where the communication quality degrades, re-sending is repeated between the operator station and the base transmitting station, and a delay occurs due to the re-sending.

“Receiving candidate” is a flag showing that the mobile station is selected as one of the mobile stations 1a through 1c for an incoming call in consideration of each of the items. A flag of “1 (pertinent)” is written in a column at the selected operator station.

Incidentally, flag data and the like shown in FIG. 5 are mere examples, thus various forms may be taken to express these.

(3-2-2) Resource Managing Unit 5 and the Like

The resource managing unit 5 manages a state of resource relating to a communication band of each cell with respect to each of the plural operator radio stations, whereby states of resource relating to communications of the operators are managed. The state of resource signifies a band of a radio channel that can be secured between a mobile station 1a, 1b or 1c and a corresponding base transmitting station 101, 102, or 112. The resource managing unit 5 obtains the data from the mobile switched network 40.

The resource managing unit 5 has an adjacent cell state judging unit 51. The adjacent cell state judging unit 51 judges states of the adjacent cells of a cell to which each of the mobile stations 1a through 1c belongs. The state of adjacent cells is congestion state relating to a cell obtained on the basis of a state of resource and a threshold value beforehand prepared. For example, when the mobile station 1a, 1b or 1c is in the cell 134 shown in FIG. 6, the adjacent cell state judging unit 51 judges as to whether each of cells 131 through 133 and 135 through 137, which are adjacent to the cell 134, secures a predetermined band or not. The adjacent cell state judging unit 51 makes judgement using the adjacent cell information management table 24d and the cell congestion state management table 24e. Namely, the individual subscriber communication quality estimating unit 100 manages communication states of cells adjacent to a cell to which each of the operators belongs, thereby estimating communication quality information.

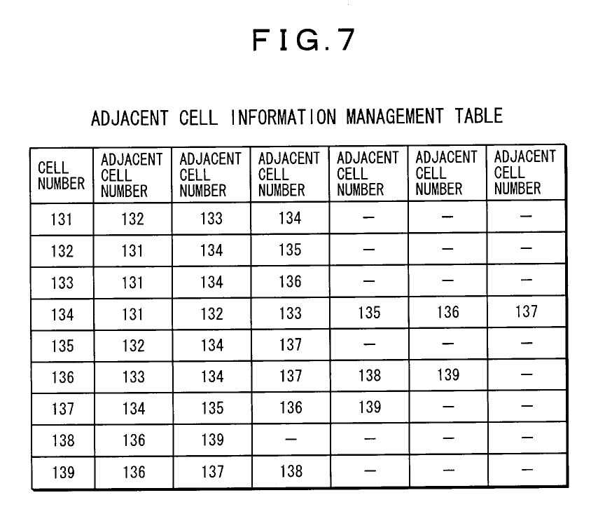

FIG. 7 is a diagram showing an example of the adjacent cell information management table 24d according to the embodiment of this invention, in which adjacent cell numbers of, for example, the cell 134 are written in detail. Namely, the adjacent cell information management table 24d holds a cell 131 and others around a cell (for example, the cell 134) to which the present position of the mobile station 1a, 1b or 1c belongs. Data once held is so-called static data, which is not updated normally. Incidentally, contents of the adjacent cell information management table 24d correspond to a case where the arrangement of cells in the mobile switched network 40 is equivalent to one shown in the cell arrangement diagram (refer to FIG. 6).

The cell congestion state management table 24e holds the state of resource of each of the cells (for example, the cells 131 through 137). The contents of it are dynamically updated every moment.

The radio quality measuring unit 3 of the individual subscriber communication quality estimating unit 100 measures the radio quality of each of the mobile stations 1a through 1c, thus an incoming call can be connected to a mobile stations 1a, 1b or 1c having a better state of radio quality. Since the resource managing unit 5 of the individual subscriber communication quality estimating unit 100 manages a state of use of the radio resource of each cell, a radio resource necessary to obtain a desired communication quality can be secured. Whereby, an incoming call can be connected to a mobile station 1a, 1b or 1c having a high communication quality.

Since the resource managing unit 5 includes the adjacent cell state judging unit 51 managing states of use of the adjacent cells to a cell used by the operator radio station, an incoming call can be connected to a mobile station 1a, 1b or 1c which can maintain a sufficient communication quality even after the operator moves to the adjacent cell during the communication.

(3-2-3) Movement Frequency Managing Unit 8 and Movement Frequency Management Table 24f

The movement frequency managing unit 8 outputs a frequency of movement of each of the mobile stations 1a through 1c into and out of a corresponding cell 131, 132, . . . , or 137, which can access to the movement frequency management table 24f holding movement frequencies.

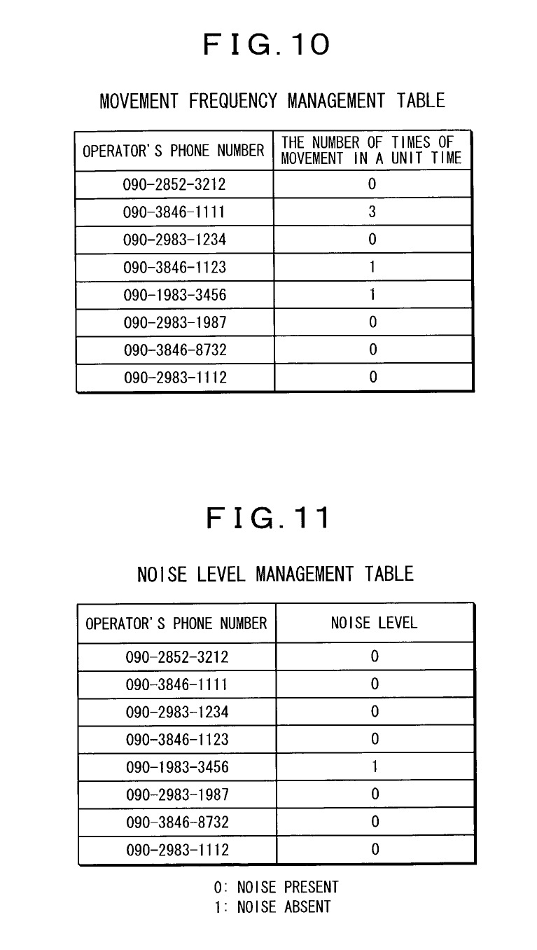

FIG. 10 is a diagram showing an example of the movement frequency management table 24f according to the embodiment of this invention. The movement frequency management table 24f shown in FIG. 10 holds the number of times of hand-over of each of the mobile stations 1a through 1c while the mobile stations 1a, 1b or 1c is used. While the mobile station 1a, 1b or 1c is not used, the number of times of registration of the position of the mobile station 1a, 1b or 1c is held.

The movement frequency managing unit 8 measures how many times each of the mobile stations 1a through 1c moves into and out of a cell to which the operator belongs on the basis of the number of times of hand-over or the number of times of registration of the position, which are held therein. Namely, the individual subscriber communication quality estimating unit 100 manages the movement frequency of each operator radio station, thereby estimating the communication quality information. Thus, an incoming call can be connected to a mobile station 1a, 1b or 1c having a low frequency of movement.

(3-2-4) Noise Level Judging Unit 9 and Noise Level Management Table 24g

The noise level judging unit 9 judges noise around each of the mobile stations 1a through 1c detected by the noise level detecting unit 14. Namely, the noise level judging unit 9 beforehand prepares a threshold value relating to the noise level, compares a noise level transmitted from each of the mobile stations 1a through 1c with the threshold value, and judges as to whether each of the mobile stations 1a through 1c is in an environment where the noise is great or small.

The noise level management table 24g holds measured noise levels, along with the threshold value relating to the above noise levels.

FIG. 11 is a diagram showing an example of the noise level management table 24g according to the embodiment of this invention. Data held in the noise level management table 24g shown in FIG. 11 is read by the noise level judging unit 9.

As above, it is possible to specialize the mobile stations 1a through 1c, and apply them to the call center 20.

(3-3) Modifications

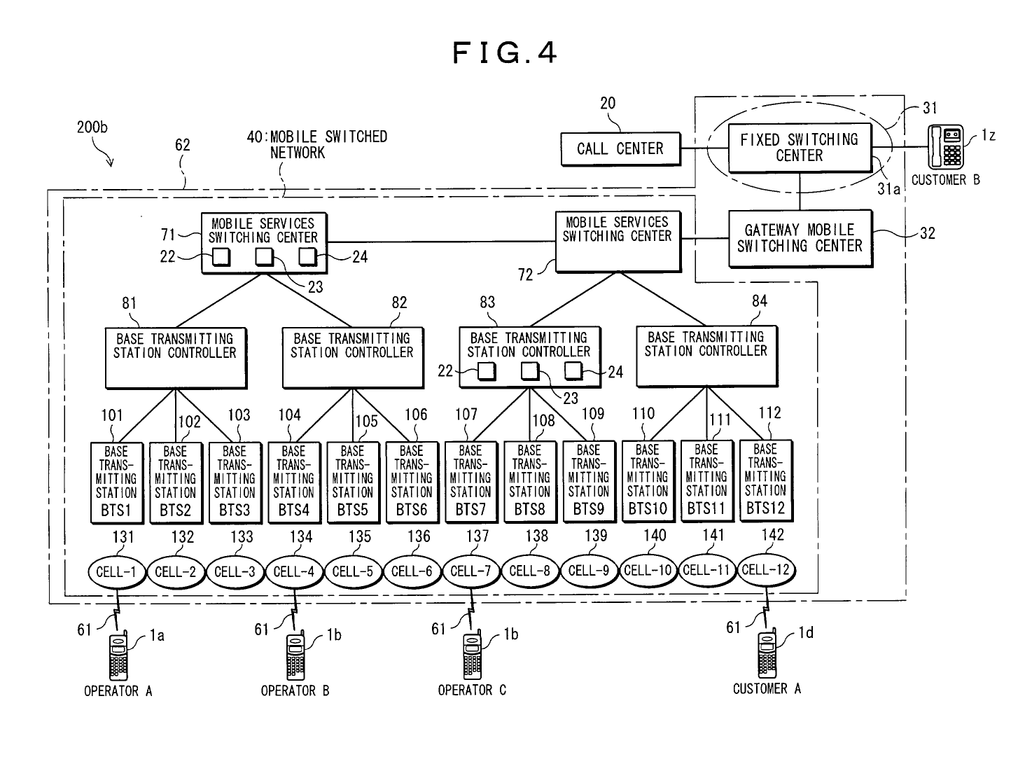

FIG. 4 is a diagram showing a modification of the mobile call center system according to the embodiment of this invention. The call center 20 of the mobile call center system 200b shown in FIG. 4 does not have the incoming call distributing unit (22, 23 and 24) configured with the call center control unit 22, the receiving station selecting unit 23 and the first information managing unit 24, which has been described above with reference to FIG. 3, but the mobile switching station 71 or the base transmitting station controller 83 shown in FIG. 4 has the incoming call distributing unit (22, 23 and 24). The incoming call distributing unit (22, 23 and 24) may be disposed in the mobile switching station 72 or the base transmitting station controller 81, 82 or 84. Alternatively, it is possible to distribute the functions of the incoming call distributing unit (22, 23 and 24), and configure the mobile call center system.

As above, by disposing the incoming call distributing unit (22, 23 and 24) in various places, it is possible to provide careful services coping with an increase/decrease in number of the mobile stations.

(4) Description of the Operation

Now, detailed description will be made of a method of estimating the communication quality of or the communication quality information on each receiving subscriber, a method of distributing radio incoming calls in the mobile call center system 200 (or 200a or 200b) having the above structure according to the embodiment of this invention, and the outline of the mobile call center system.

There are generally four elements for estimating the communication quality information on the mobile stations 1a through 1c: \mathring{1} radio quality, \mathring{2} state of resource, \mathring{3} frequency of movement, and \mathring{4} noise level. Hereinafter, description will be made of a method of realizing measurement required to estimate each of the elements.

(4-1) Method of Estimating the Communication Quality Of or the Communication Quality Information On Individual Subscriber

When the customer B calls the key number, the call center control unit 22 notifies the incoming station determining unit 4 in the call center 20 shown in FIG. 2 of an incoming call. The receiving station determining unit 4 refers the group registration table (refer to FIG. 5) 24a managed in the first information managing unit 24 by the individual subscriber communication quality estimating unit 100, extracts operators' telephone numbers corresponding to the key number, and refers to the sign-on states and busy-idle states of the extracted operators' telephone numbers.

In order to determine receiving candidate stations among operator telephone numbers that are in both the sing-one state and the idle state on the basis of the radio quality after reference to them, the receiving station determining unit 4 activates the radio quality measuring unit 3. The radio quality measuring unit 3 requests the call center control unit 22 to collect results of radio quality measurement executed each time the position of the operator is registered in order to measure the radio qualities of the designated operators' telephone numbers. The call center control unit 22 transmits the request to collect results of the radio quality measurement to the mobile switched network 40 via the message transmitting-receiving unit 21.

The mobile switched network control unit 42 (refer to FIG. 2) disposed in each of the base transmitting station controllers 81 through 84 in the mobile switched network 40 requests the second information managing unit 43 to read information on the operators' telephone number designated by the call center 20, and transmits a result of the radio quality measurement obtained from the second information managing unit 43 to the call center 20 via the data transmitting-receiving unit 21.

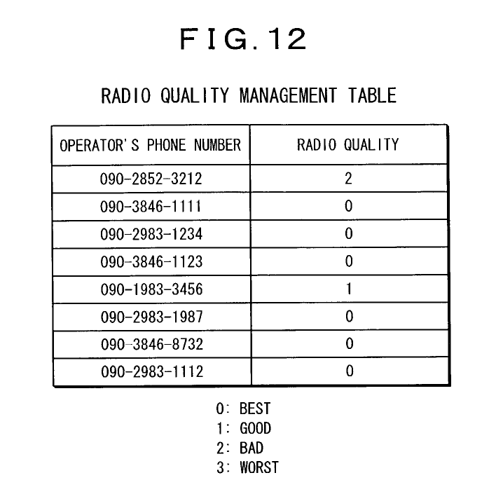

The call center control unit 22 notifies the radio quality measuring unit 3 of received results of the radio quality measurement. The radio quality measuring unit 3 writes the results of the radio quality measurement in the radio quality management table 24b (refer to FIG. 12), after that, ranks the results of the radio quality measurement, and makes results of the ranking be reflected to “radio quality” of the group registration table 24a.

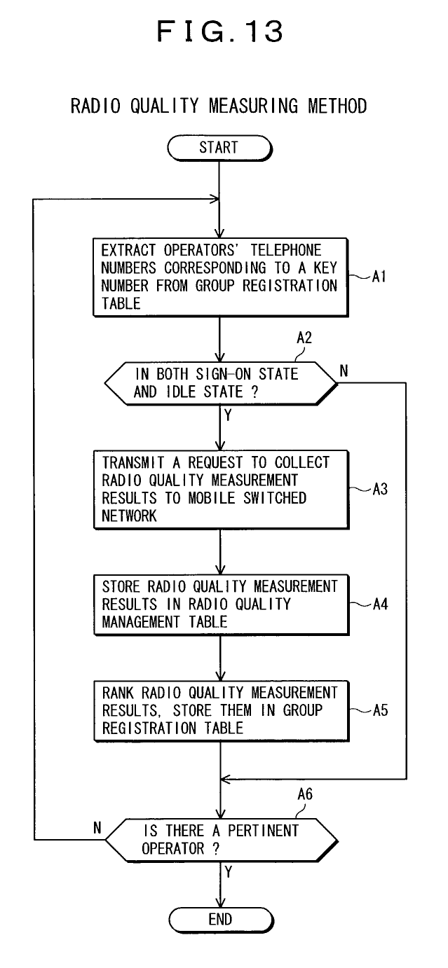

FIG. 13 is a flowchart for illustrating the radio quality measuring method according to the embodiment of this invention. At step A1 shown in FIG. 13, operators' telephone numbers corresponding to a key telephone number are extracted from the group registration table 24a, and conditions of whether each of them is in both the sign-on state and the idle state are checked (step A2). When these conditions are satisfied, the procedure takes the Y route, and a request to collect results of radio quality measurement is transmitted to the mobile switched network 40 (step A3). Results of the radio quality measurement are written in the radio quality management table 24b (step A4). The results of the radio quality measurement are ranked, and written in the group registration table 24a (step A5). At step A6, presence or absence of a pertinent operator is checked. When there is no pertinent operator, the procedure takes the N route, and the process from step A1 is repeated. When the above conditions are not satisfied at step A2, the procedure takes the N route, and the process at step A6 is executed.

Since an operator in a good state of the radio quality is determined in response to an inquiry from a customer on the telephone or a request to order a product, or the like, it is possible to avoid interruption of the communication with the customer due to degradation of the radio quality. On the other hand, the operator can do the operator work by the computer using the mobile station 1a, 1b or 1c.

(4-2) Resource State Measuring Method

In the mobile call center system 200, when a customer calls the key number, the call center control unit 22 notifies the receiving station determining unit 4 of it. The receiving station determining unit 4 extracts operators' telephone numbers corresponding to the key number from the group registration table 24a managed in the first information managing unit 24 by the individual subscriber communication quality estimating unit 100, and refers to the sign-on state and the busy/idle state of the extracted operators' telephone numbers.

When the extracted operators' telephone numbers are in both the sign-on state and the idle state as results of the reference, the call center control unit 22 activates the resource managing unit 5 with respect to the operators' telephone numbers. The resource managing unit 5 transmits a request to collect information on cells to which the mobile stations 1a through 1c of the designated operators' telephone numbers and a state of resource of each of the cells to the call center control unit 22. The call center control unit 22 transmits the request to collect the cell information and states of resource to the mobile switched network 40 via the message transmitting-receiving unit 21.

Each of the mobile switched network control units 42 in the mobile switched network 40 extracts the operators' telephone number designed by the call center 20, and requests the first information managing unit 24 to read information on a cell to which the mobile station 1a, 1b or 1c having the number belongs and a state of use of the radio resource of the cell. When obtaining cell information and a state of radio resource use of the cell from the first information managing unit 24, the mobile switched network control unit 42 transmits them to the call center 20 via the data transmitting-receiving unit 41.

The call center 20 and the call center control unit 22 notify the resource managing unit 5 of received cell information and states of use of the radio resource of the cells received the resource managing unit 5. The resource managing unit 5 writes the cell information in the column of “accommodating cell” of the group registration table 24a, while writing the states of resource of the cells to which the mobile stations 1a through 1c used by the operators belong in the column of “resource condition” of the group registration table 24a. The call center 20 and the call center control unit 22 also write the states of use of the radio resource of the cells in the resource management table 24c. After that, the call center 20 and the call center unit 22 requests the adjacent cell state judging unit 51 to judge the states of radio resource of the adjacent cells.

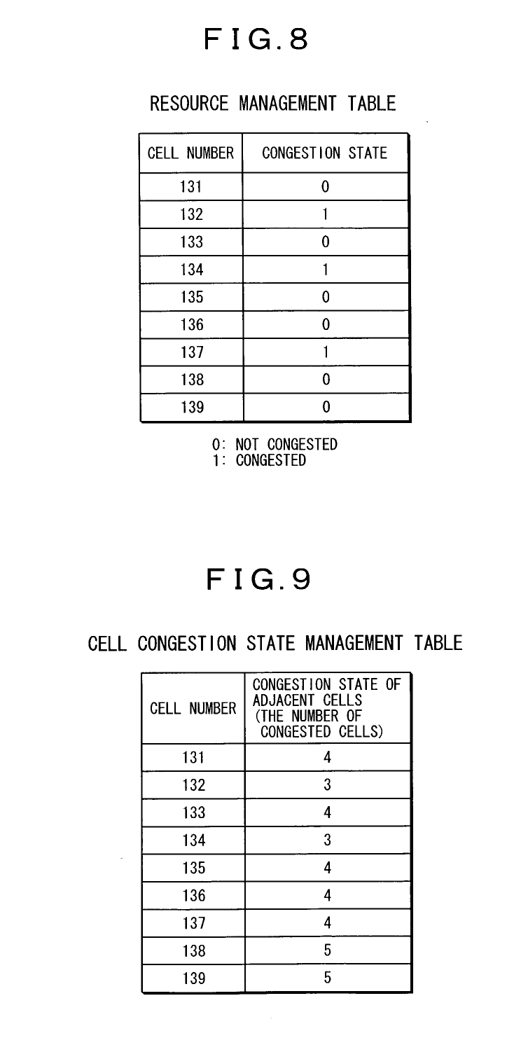

FIG. 8 is a diagram showing an example of the resource management table 24c according to the embodiment of this invention. Presence/absence of congestion is written in a column at each cell number in the resource management table 24c shown in FIG. 8.

The adjacent cell state judging unit 51 extracts cells adjacent to the cells to which the mobile stations 1a through 1c of the designated operators' telephone numbers belong from the adjacent cell information management table 24d, and extracts states of radio resource of the cells from the resource management table 24c.

FIG. 9 is a diagram showing an example of the cell congestion state management table 24e according to the embodiment of this invention. In the cell congestion state management table 24e shown in FIG. 9, each of the congestion states of adjacent cells to each cell is represented by the number of congested cells.

At a point of time when extraction of states of radio resource of all the adjacent cells, the number of cells in the congested state is written as a state of radio resource of the adjacent cells in the cell congestion state management table 24e. The adjacent cells are ranked according to states of the radio resource, and results of the ranking are written in the column of state of adjacent cells of the group registration table 24a. When there is no adjacent cell, it is handled as in the congested state.

As above, the congestion states of the cells adjacent to the cells used by the mobile stations 1a through 1c are recognized. On the basis of results of the recognition, the receiving station determining unit 4 determines not less than one desired mobile station 1a, 1b or 1c in a cell having adjacent cells having low possibility of causing congestion, among available mobile stations for a call, as the receiving station or the receiving candidate station. Whereby, an incoming call can be connected to a mobile station 1a, 1b or 1c in a cell having adjacent cells having low possibility of causing congestion.

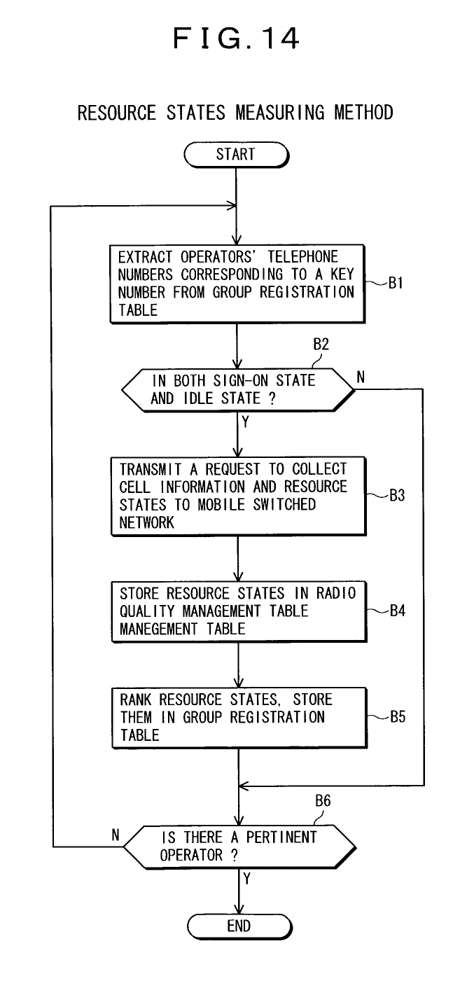

FIG. 14 is a flowchart for illustrating the resource state measuring method according to the embodiment of this invention. At step B1 shown in FIG. 14, operators' telephone numbers corresponding to the key telephone number are extracted from the group registration table 24a, and conditions of whether each of them is in both the sign-on state and the idle state are checked (step B2). When these conditions are satisfied, the procedure takes the Y route, and a request to collect cell information and states of resource is transmitted to the mobile switched network 40 (step B3). States of resource are written in the radio quality management table 24b (step B4). The states of resource are ranked, and written in the group registration table 24a (step B5). At step B6, presence/absence of a pertinent operator is checked. When there is no pertinent operator, the procedure takes the N route, and the process from step B1 is repeated. When the above conditions are not satisfied at step B2, the procedure takes the N route, and the process at step B6 is executed.

Accordingly, the resource state measuring method and the radio quality measuring method are analogous to each other, the processes of which are almost common. For this, it is possible to design a common routine in the both method at the time of coding, thus a ROM (Read Only Memory) can be used efficiently.

States of the radio resource of available mobile stations 1a through 1c for an incoming call are managed as above, and not less than one mobile station 1a, 1b or 1c is determined as the receiving station or the receiving candidate station among available mobile stations 1a through 1c for the incoming call on the basis of the states of the resource. Accordingly, a call from a customer can be connected to a mobile station 1a, 1b or 1c having a good radio state.

Since states of the resource are measured along with the radio qualities, it is possible to determine not less than one desired mobile station 1a, 1b or 1c having a good radio quality among a plurality of available mobile stations 1a through 1c for an incoming call. The customer can thus talk with a mobile station 1a, 1b or 1c having a good radio quality.

(4-3) Movement Frequency Measuring Method

In the mobile call center system 200, when a customer calls the key number, the call center control unit 22 notifies the receiving station determining unit 4 of it. The receiving station determining unit 4 extracts operators' telephone numbers corresponding to the key number from the group registration table 24a (refer to FIG. 5) managed in the first information managing unit 24 by the individual subscriber communication quality estimating unit 100, and refers to the sign-on state and the busy/idle state of the operators' telephone numbers.

When the extracted numbers are in both the sign-on state and the idle state as a result of the reference, the incoming station determining unit 4 activates the movement frequency managing unit 8 in order to determine a receiving operator of any one of the operators' telephone numbers on the basis of the movement frequency.

The movement frequency managing unit 8 transmits a request to collect movement frequency information on the designated operators' telephone numbers to the mobile switched network control unit 42. The mobile switched network control unit 42 transmits the request to collect the movement frequency information to the mobile switched network 40 via the message transmitting-receiving unit 21. When receiving the request to collect the movement frequency information from the call center 20, the mobile switched network control unit 42 obtains histories of execution of hand-over of the pertinent operators' telephone numbers from the first information managing unit 24, and transmits them to the call center 20 via the data transmitting-receiving unit 41. The call center control unit 22 notifies the movement frequency managing unit 8 of the received movement histories.

After writing the movement histories in the movement frequency management table 24f (refer to FIG. 10), the movement frequency management unit 8 determines ranks of the movement histories, and writes them in the column of “movement frequency” of the group registration table 24a (FIG. 5).

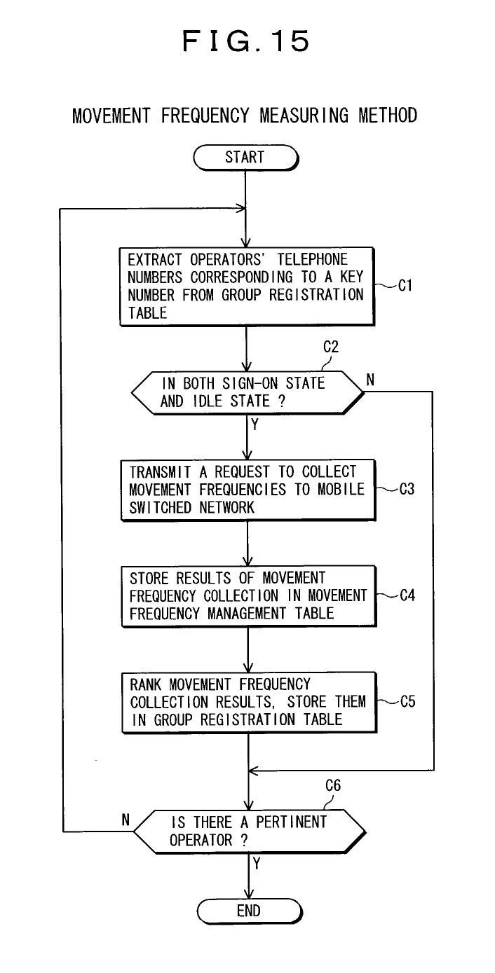

FIG. 15 is a flowchart for illustrating the movement frequency measuring method according to the embodiment of this invention. At step C1 in FIG. 15, operators' telephone numbers corresponding to the key telephone number are extracted from the group registration table 24a, and conditions of whether they are in both the sign-on state and the idle state are checked (step C2). When the conditions are satisfied, the procedure takes the Y route, and a request to collect the movement frequencies is transmitted to the mobile switched network 40 (step C3). Results of the collection of the movement frequencies are written in the movement frequency management table 24f (step C4). The results of the collection of the movement frequencies are ranked, and written in the group registration table 24a (step C5). At step C6, presence/absence of a pertinent operator is checked. When there is no pertinent operator, the procedure takes the N route, and the process from step C1 is repeated. When the above conditions are not satisfied at step C2, the procedure takes the N route, and the process at step C6 is executed.

The movement frequencies of the mobile stations 1a through 1c are measured as above, and not less than one desired mobile station 1a, 1b or 1c having a low frequency of movement is determined as the receiving station or the receiving candidate station among a plurality of available mobile stations 1a through 1c for an incoming call. A call from the customer can thereby be connected to a mobile station 1a, 1b or 1c having a low movement frequency.

(4-4) Noise Level Measuring Method

In the mobile call center system 200, when a customer calls the key number, the call center control unit 22 notifies the incoming station determining unit 4 of it. The incoming station determining unit 4 extracts operators' telephone numbers corresponding to the key number from the group registration table 24a (refer to FIG. 5) managed in the first information managing unit 24 by the individual subscriber communication quality estimating unit 100, and refers to the sign-on state and the busy/idle state of the operators' telephone numbers.

When the extracted numbers are in both the sign-on state and the idle state as results of the reference, the incoming station determining unit 4 activates the noise level judging unit 9 in order to determine a receiving operator of any one of the operators' telephone numbers on the basis of the noise level. The noise level judging unit 9 makes a request to collect noise level information on the designated operator telephone numbers to the call center control unit 22. The call center control unit 22 transmits the request to collect the noise levels to the mobile switched network 40 via the message transmitting-receiving unit 21.

When receiving the request to collect the noise level information from the call center 20, each of the mobile switched network control units 42 obtains the noise level information on the pertinent operator's telephone number from the second information managing unit 43, and transmits it to the call center 20 via the data transmitting-receiving unit 41. The call center control unit 22 notifies the noise level judging unit 9 of the received noise level information. The noise level judging unit 9 writes the noise level information in the noise level management table 24g (refer to FIG. 11), after that, ranks the noise levels, and writes them in the column of noise level of the group registration table 24a (FIG. 5).

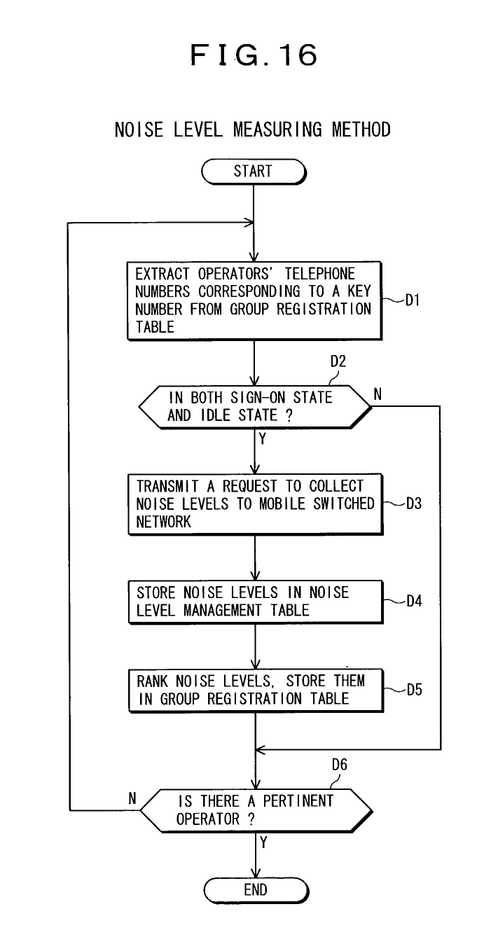

FIG. 16 is a flowchart for illustrating the noise level measuring method according to the embodiment of this invention. At step D1 shown in FIG. 16, operators' telephone numbers corresponding to the key telephone number are extracted from the group registration table 24a, and conditions of whether they are in both the sign-on state and the idle state are checked (step D2). When the conditions are satisfied, the procedure takes the Y route, and a request to collect noise levels is transmitted to the mobile switched network 40 (step D3). The noise levels are written in the noise level management table 24g (step D4). The noise levels are ranked, and written in the group registration table 24a (step D5). At step D6, presence/absence of a pertinent operator is checked. When there is no pertinent operator, the procedure takes the N route, and the process from step D1 is repeated. When the above conditions are not satisfied at step D2, the procedure takes the N route, and the process at step D6 is executed.

Since noise around each of the mobile stations 1a through 1c is detected and notified to the noise level judging unit 9, it is possible to determine not less than one desired mobile station 1a, 1b or 1c having smaller noise as the receiving station or the receiving candidate station among a plurality of available mobile stations 1a through 1c for an incoming call. The call from the customer can thereby be connected to a mobile station 1a, 1b or 1c having small noise.

(4-5) Incoming Candidate Operator Determining Method

In the mobile call center system 200, when a customer calls the key number, the call center control unit 22 notifies the incoming station determining unit 4 of it. After the individual subscriber communication quality estimating unit 100 collects elements to determine receiving candidates, the receiving station selecting unit 23 activates the receiving station determining unit 4.

The receiving station determining unit 4 refers to elements (radio quality, state of resource, state of adjacent cells, movement frequency, noise level) other than throughput written in the group registration table 24a managed by the first information managing unit 24, and determines receiving candidate stations. In an example of the determination, the following calculation is done to determine operators having values below a reference value as the receiving candidate stations, wherein * represents multiplication:

“radio quality” * 16+“state of resource” * 8+“state of adjacent cells” * 4+“movement frequency” * 2+“noise level”

Here, an order of priority is “radio quality”>“state of resource”>“state of adjacent cells”>movement frequency”>“noise level.” Incidentally, the order of priority and values of coefficients may be changed in various ways.

The receiving station determining unit 4 writes the determined receiving candidates in the group registration table 24a.

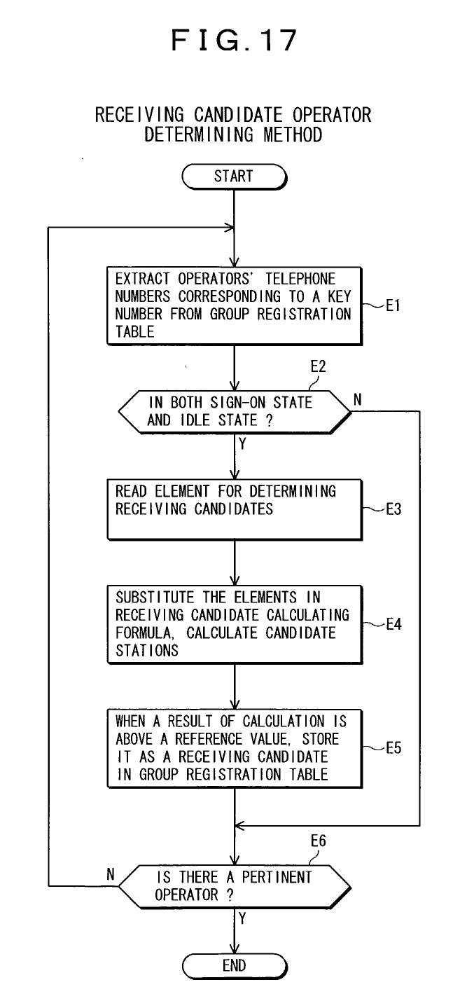

FIG. 17 is a flowchart for illustrating the receiving candidate operator determining method according to the embodiment of this invention. At step E1 shown in FIG. 17, operators' telephone numbers corresponding to the key telephone number are extracted from the group registration table 24a, and conditions of whether they are in both the sign-on state and the idle state are checked (step E2). When the conditions are satisfied, the procedure takes the Y route, and each of the elements for determining receiving candidates is read (step E3). Ranks of the respective elements are substituted in the receiving candidate calculating formula to calculate candidate stations (step E4). At step E5, when a result of the calculation is not less than the reference value, it is written as the receiving candidate in the group registration table 24a. At step E6, presence/absence of a pertinent operator is checked. When there is no pertinent operator, the procedure takes the N route, and the process from step E1 is repeated. When the above conditions are not satisfied at step E2, the procedure takes the N route, and the process at step E6 is executed.

(4-6) Responding Operator Determining Method

In the mobile call center system 200, when a customer calls the key number, the call center control unit 22 notifies the incoming station determining unit 4 of it. After the individual subscriber communication quality estimating unit 100 collects elements for determining receiving candidates, the receiving station selecting unit 23 activates the receiving station determining unit 4. After the incoming station determining unit 4 determines receiving candidates, the throughput measuring unit 6 makes a request to execute the pseudo test to the call center control unit 22 in order to measure the throughput of each of the receiving candidate stations. The call center control unit 22 transmits the request to execute the pseudo test to the mobile switched network 40 via the message transmitting-receiving unit 21.

Each of the mobile switched network control units 42 requests the second information managing unit 43 for the pseudo test on the operator station designated by the call center 20. The station managing unit 44 in the mobile switched network 40 transmits and receives data of a unit quantity to and from the designated operator station as the pseudo test to measure a throughput, and notifies the mobile switched network control unit 42 of a result of the measurement as a result of the test. The mobile switched network control unit 42 transmits the result of the test to the call center 20 via the data transmitting-receiving unit 41. The call center control unit 22 notifies the throughput measuring unit 6 of received test results.

The throughput measuring unit 6 writes the test results in a column of “throughput” of the group registration table 24a (FIG. 5), then requests the responding station determining unit 7 to determine a responding station. The responding station determining unit 7 refers to each of the elements (radio quality, state of resource, state of adjacent cells, movement frequency, noise level, throughput) of the group registration table 24a (FIG. 5), determines a responding station on the basis of the priority of the elements, the number of past incoming calls, etc., and notifies the call center control unit 22 of it in order to make the responding station be brought into a talkable state with the customer.

As above, not less than one desired receiving station or receiving candidate station is determined by the receiving station determining unit 4, data is transferred by the throughput measuring unit 6, and a mobile station 1a, 1b or 1c is determined as a responding station after the first reception by the responding station determining unit 7 is completed. Whereby, the call can be connected to a mobile station 1a, 1b or 1c having the best communication quality.

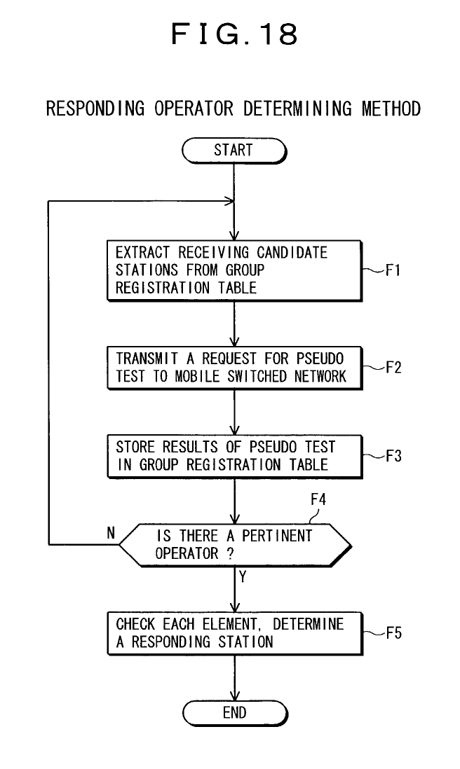

FIG. 18 is a flowchart for illustrating the responding operator determining method according to the embodiment of this invention. At step F1 shown in FIG. 18, operators' telephone numbers corresponding to the key number are extracted from the group registration table 24a. At step F2, a request for the pseudo test is transmitted to the mobile switched network 40. At step F3, results of the pseudo test are written in the group registration table 24a. At step F4, presence/absence of a pertinent operator is checked. When there is no pertinent operator, the procedure takes the N route, and the process from the step F1 is again repeated. When there is a pertinent operator, the procedure takes the Y route. At step F5, each of the elements is checked to determine a responding station.

As shown in FIGS. 13 through 18, the radio quality, the state of resource, the movement frequency, the noise level, the receiving candidate operators and the responding operator are measured and determined. Accordingly, a customer can obtain stable communication.

According to the incoming call radio distributing apparatus 20, it is possible to determine an operator of a high communication quality, thus to secure high-quality speech with a customer. It is also possible to determine an operator who can secure a sufficient transmission band, thus to secure a throughput when data of a customer is transferred.

Further, each enterprise can secure a number of operators, determine an operator who is difficult to be disconnected, and avoid possibility of loss of business talk with a customer. The call center 20 can specify an operator having a low movement frequency, avoid a possibility of disconnection due to hand-over, determine an operator having a low possibility of congestion of the adjacent cells, and avoid disconnection due to exhaustion of the resource in a cell to which the mobile station moves.

(B) Others

Note that the present invention is not limited to the above examples, but may be modified in various ways without departing from the scope of the invention.

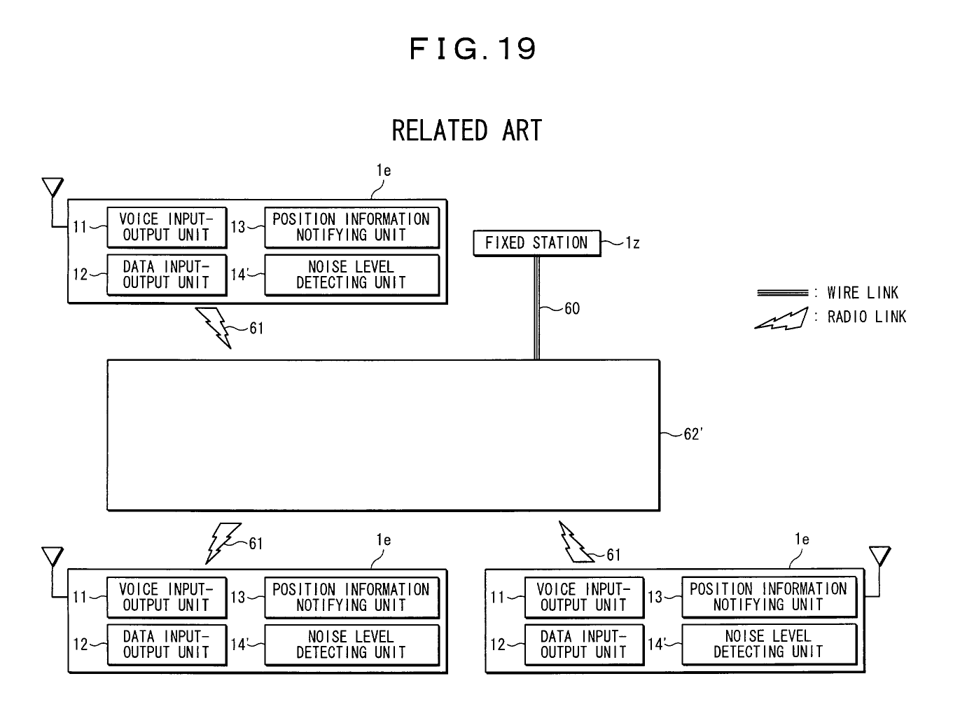

FIG. 19 is a diagram showing an example of the known technique. A mobile station 1e shown in FIG. 19 has a general communication function, but without a function for transmitting/receiving communication quality information. The mobile station 1e and a communication network 62′ are independent of each other. The communication network 62′ is a wire or radio communication network without the call center control unit 22 and the receiving station selecting unit 23. A noise level detecting unit 14′ is to remove noise around the mobile station 1e for the purpose of improving the speech quality.

1. An incoming call radio distributing apparatus distributing incoming calls to radio stations comprising:
a selecting unit for selecting an available operator radio station for an incoming call among a plurality of operator radio stations for responding to incoming calls on the basis of states of communication of said plural operator radio stations; and
an incoming call distributing unit for preferentially connecting the incoming call to said available operator radio station selected by said selecting unit.

2. The incoming call radio distributing apparatus according to claim 1, wherein said selecting unit has a communication quality estimating unit for estimating information on communication qualities of a plurality of operator radio stations for responding to incoming calls;
said communication quality estimating unit comprises:
a radio quality measuring unit for measuring a radio quality of each of said plural operator radio stations; and
a resource managing unit for managing a state of resource relating to a communication band of each cell with respect to each of said plural operator radio stations.

3. The incoming call radio distributing apparatus according to claim 1, wherein said selecting unit comprises:
a communication quality estimating unit for estimating information on communication qualities of a plurality of operator radio stations for responding to incoming calls;
an information managing unit for managing operator radio station information on available operator radio stations for an incoming call among said plural operator radio stations on the basis of information on communication qualities of said communication quality estimating unit;
a receiving station determining unit for determining operator radio stations for the incoming call on the basis of operator radio terminal information managed by said information managing unit;
a throughput measuring unit for transferring predetermined data to each of the operator stations for the incoming call determined by said receiving station determining unit, and measuring a receiving state of sent-back data therefrom; and
a responding station determining unit for determining an operator radio station for the incoming call among a plurality of available operator radio stations for the incoming call grouped by said information managing unit on the basis of measurement by said throughput measuring unit.

4. The incoming call radio distributing apparatus according to claim 1, wherein said selecting unit comprises:
a receiving station determining unit for estimating information on communication qualities of a plurality of operator radio stations for responding to incoming calls, managing operator radio station information on available operator radio stations for an incoming call among said plural operator radio stations on the basis of estimated information on radio qualities, and determining operator radio stations for the incoming call on the basis of managed operator radio station information;
a throughput measuring unit for transferring predetermined data to each of operator radio stations for the incoming call determined by said receiving station determining unit, and measuring a receiving state of sent-back data therefrom; and
a responding station determining unit for determining an operator radio station for the incoming call among plural available operator radio stations for the incoming call grouped by said receiving station determining unit on the basis of measurement by said throughput measuring unit.

5. The incoming call radio distributing apparatus according to claim 3, wherein said information managing unit has a table holding at least not less than one kind of information on radio qualities, states of resource, states of adjacent cells, frequencies of movement, noise levels or throughputs of said plural operator radio stations.

6. An incoming call radio distributing apparatus distributing incoming calls to radio stations comprising:
a communication quality estimating unit for estimating information on communication qualities of a plurality of operator radio stations for responding to incoming calls;
an information managing unit for managing operator radio station information on available operator radio stations for an incoming call among said plural operator radio stations on the basis of information on communication qualities of said communication quality estimating unit; and
a receiving station determining unit for determining operator radio stations for the incoming call on the basis of operator radio terminal information managed by said information managing unit.

7. The incoming call radio distributing apparatus according to claim 6, wherein said communication quality estimating unit comprises:
a radio quality measuring unit for measuring radio qualities of said plural operator radio stations; and
a resource managing unit for managing a state of resource relating to a communication band of each cell with respect to each of said plural operator radio stations.

8. The incoming call radio distributing apparatus according to claim 7 further comprising:
a throughput measuring unit for transferring predetermined data to each of operator radio stations for the incoming call determined by said receiving station determining unit, and measuring a receiving state of sent-back data therefrom; and
a responding terminal determining unit for determining an operator radio station for the incoming call among a plurality of available operator radio stations for the incoming call grouped by said information managing unit on the basis of measurement by said throughput measuring unit.

9. The incoming call radio distributing apparatus according to claim 6, wherein said communication quality estimating unit estimates information on a communication quality by managing states of communication of adjacent cells to a cell to which each operator radio station belongs.

10. The incoming call radio distributing apparatus according to claim 6, wherein said communication quality estimating unit estimates information on a communication quality by managing a frequency of movement of each operator radio station.

11. The incoming call radio distributing apparatus according to claim 6, wherein said communication quality estimating unit estimates information on a communication quality on the basis of a noise level around at least said operator radio station.

12. The incoming call radio distributing apparatus according to claim 6 further comprising:
a throughput measuring unit for transferring predetermined data to each of operator radio stations for the incoming call determined by said receiving radio station determining unit, and measuring a receiving state of sent-back data therefrom; and
a responding terminal determining unit for determining an operator radio station for the incoming call among a plurality of available operator radio stations for the incoming call grouped by said information managing unit on the basis of measurement by said throughput measuring unit.

13. The incoming call radio distributing apparatus according to claim 6, wherein said information managing unit has a table holding at least not less than one kind of information on radio qualities, states of resource, states of adjacent cells, frequencies of movement, noise levels or throughputs of said plural operator radio stations.

14. A mobile call center system in which a plurality of operators receive a plurality of incoming calls comprising:
a plurality of operator radio stations for responding to incoming calls;
a selecting unit for selecting an available operator radio station for an incoming call among said plural operator radio stations on the basis of states of communication of said plural operator radio stations; and
an incoming call distributing unit for preferentially connecting the incoming call to said available operator radio station selected by said selecting unit.

15. A mobile call center system in which a plurality of operators receive a plurality of incoming calls comprising:
a plurality of operator radio stations for responding to incoming calls;
a communication quality estimating unit for estimating information on communication qualities of said plural operator radio stations;
an information managing unit for managing operator radio station information on available operator radio stations for an incoming call among said plural operator radio stations on the basis of information on communication qualities of said communication quality estimating unit; and
a receiving station determining unit for determining an operator radio station for the incoming call on the basis of operator radio station information managed by said information managing unit.

16. An operator radio station responding to an incoming call coming in to an incoming call radio distributing apparatus distributing incoming calls to radio terminals comprising:
a radio transmitting-receiving unit for transmitting and receiving radio signals including sent-back data; and
a noise level detecting unit for detecting a noise level therearound, and inputting data relating to the noise level to said radio transmitting-receiving unit.
